(19) United States
(12) Patent Application Publication
(10) Pub. No.: US 2024/0311181 A1
(43) Pub. Date: Sep. 19, 2024

(54) STATEFUL ENDPOINT MOBILITY IN A FEDERATED CLOUD COMPUTING SYSTEM

(71) Applicant: TELEFONAKTIEBOLAGET LM ERICSSON (PUBL), Stockholm (SE)

(72) Inventors: Miika Komu, HELSINKI (FI); Tero Kauppinen, ESPOO (FI); Jemal Tahir, Espoo (FI); Jimmy Kjällman, ESPOO (FI)

(21) Appl. No.: 18/576,787

(22) PCT Filed: Jul. 6, 2021
(86) PCT No.: PCT/IB2021/056058

§ 371 Date: Jan. 5, 2024

(51) Int. Cl. G06F 9/48; G06F 9/50

(52) U.S. Cl. CPC G06F 9/4856; G06F 9/5038

(57) ABSTRACT

A method by a master orchestrator in a federated cloud computing system to move an endpoint between clusters. The method includes receiving a request to move a first endpoint implemented in a first cluster to another cluster, wherein the first endpoint provides a service and uses a first database to store state associated with the service, responsive to receiving the request, causing a second endpoint and a second database to be deployed in a second cluster, wherein the second endpoint is a replica of the first endpoint, the second database is a replica of the first database, and the second endpoint is to use the second database to store state, causing synchronization between the first database and the second database to begin, causing the first endpoint to use the second database instead of the first database, and causing clients to use the second endpoint instead of the first endpoint.

### TECHNICAL FIELD

Embodiments of the invention relate to the field of cloud computing, and more specifically to moving endpoints between different clusters in a federated cloud computing system.

### BACKGROUND

A container orchestration system such as Kubernetes may be used to automate the deployment, scaling, and operations of containerized applications. The container orchestration system may group containers that make up an application into logical units for easy management and discovery. The container orchestration system may work with a containerization tool such as Docker to run containers in clusters. Containers may be isolated from one another and bundle their own software, libraries, and configuration files. Because multiple containers can share the services of a single operating system, they typically use fewer resources compared to virtual machines.

Federation allows a containerized application that is deployed across multiple different clusters (which may be in different clouds (e.g., an Amazon cloud and a Microsoft cloud or a private cloud and a public cloud)) to be managed centrally. Thus, federation allows application developers to combine the resources of multiple separated clusters while retaining the autonomy of the individual clusters (which may be useful in the case of network partitioning, for instance). A federated container orchestration tool such as Federated Kubernetes allows application developers or devops teams (or artificial intelligence) to choose where to deploy their workloads (e.g., microservices). For example, workloads may be deployed in private clouds, public clouds, edge cloud, and/or regional clouds.

Existing federated container orchestration tools can move workloads between different clusters, but they achieve this by terminating the old instance in the old cluster and then starting a new instance in the new cluster, which results in service interruptions (e.g., if the application is providing a service to clients). Also, any state maintained by the old instance is lost.

### SUMMARY

A method by one or more computing devices implementing a master orchestrator in a federated cloud computing system to move an endpoint between clusters. The method includes receiving a request to move a first endpoint implemented in a first cluster in a first cloud to another cluster in another cloud, wherein the first endpoint provides a service and uses a first database implemented in the first cluster to store state associated with the service, responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service, causing synchronization between the first database and the second database to begin, causing the first endpoint to connect to the second database, causing the first database to be in a read-only state, causing the first endpoint to use the second database instead of the first database, causing the first endpoint to pause execution and store any uncommitted state associated with the service in the second database, and causing one or more clients to use the second endpoint instead of the first endpoint in response to a determination that the first database and the second database are synchronized and the first endpoint has stored any uncommitted state in the second database.

A set of non-transitory machine-readable media having computer code stored therein, which when executed by a set of one or more processors of one or more computing device implementing a master orchestrator in a federated cloud computing system, causes the master orchestrator to perform operations for moving an endpoint between clusters. The operations include receiving a request to move a first endpoint implemented in a first cluster in a first cloud to another cluster in another cloud, wherein the first endpoint provides a service and uses a first database implemented in the first cluster to store state associated with the service, responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service, causing synchronization between the first database and the second database to begin, causing the first endpoint to connect to the second database, causing the first database to be in a read-only state, causing the first endpoint to use the second database instead of the first database, causing the first endpoint to pause execution and store any uncommitted state associated with the service in the second database, and causing one or more clients to use the second endpoint instead of the first endpoint in response to a determination that the first database and the second database are synchronized and the first endpoint has stored any uncommitted state in the second database.

A computing device to implement a master orchestrator in a federated cloud computing system to move an endpoint between clusters. The computing device includes one or more processors and a non-transitory machine-readable medium having computer code stored therein, which when executed by the one or more processors, causes the master orchestrator to receive a request to move a first endpoint implemented in a first cluster in a first cloud to another cluster in another cloud, wherein the first endpoint provides a service and uses a first database implemented in the first cluster to store state associated with the service, responsive to receiving the request, cause a second endpoint and a second database to be deployed in a second cluster in a second cloud, wherein the second endpoint is a replica of the first endpoint, the second database is a replica of the first database, and the second endpoint is to use the second database to store state associated with the service, cause synchronization between the first database and the second database to begin, cause the first endpoint to connect to the second database, cause the first database to be in a read-only state, cause the first endpoint to use the second database instead of the first database, cause the first endpoint to pause execution and store any uncommitted state associated with the service in the second database, and cause one or more clients to use the second endpoint instead of the first endpoint in response to a determination that the first database and the second database are synchronized and the first endpoint has stored any uncommitted state in the second database.

A method by one or more computing devices implementing a master orchestrator in a federated cloud computing system to move an endpoint between clusters. The method includes receiving a request to move a first endpoint implemented in a first cluster in a first cloud to another cluster in another cloud, wherein the first endpoint provides a service and uses a first database implemented in the first cluster to store state associated with the service, responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service, causing synchronization between the first database and the second database to begin, causing the first endpoint to pause execution and store any uncommitted state associated with the service in the first database, and causing one or more clients to use the second endpoint instead of the first endpoint in response to a determination that the first database and the second database are synchronized.

A set of non-transitory machine-readable media having computer code stored therein, which when executed by a set of one or more processors of one or more computing device implementing a master orchestrator in a federated cloud computing system, causes the master orchestrator to perform operations for moving an endpoint between clusters. The operations include receiving a request to move a first endpoint implemented in a first cluster in a first cloud to another cluster in another cloud, wherein the first endpoint provides a service and uses a first database implemented in the first cluster to store state associated with the service, responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service, causing synchronization between the first database and the second database to begin, causing the first endpoint to pause execution and store any uncommitted state associated with the service in the first database, and causing one or more clients to use the second endpoint instead of the first endpoint in response to a determination that the first database and the second database are synchronized.

A computing device to implement a master orchestrator in a federated cloud computing system to move an endpoint between clusters. The computing device includes one or more processors and a non-transitory machine-readable medium having computer code stored therein, which when executed by the one or more processors, causes the master orchestrator to receive a request to move a first endpoint implemented in a first cluster in a first cloud to another cluster in another cloud, wherein the first endpoint provides a service and uses a first database implemented in the first cluster to store state associated with the service, responsive to receiving the request, cause a second endpoint and a second database to be deployed in a second cluster in a second cloud, wherein the second endpoint is a replica of the first endpoint, the second database is a replica of the first database, and the second endpoint is to use the second database to store state associated with the service, cause synchronization between the first database and the second database to begin, cause the first endpoint to pause execution and store any uncommitted state associated with the service in the first database, and cause one or more clients to use the second endpoint instead of the first endpoint in response to a determination that the first database and the second database are synchronized.

### BRIEF DESCRIPTION OF THE DRAWINGS

The invention may best be understood by referring to the following description and accompanying drawings that are used to illustrate embodiments of the invention. In the drawings:

FIG. 1 is a block diagram of a federated cloud computing system in which an endpoint can be moved between clusters in different clouds, according to some embodiments.

FIG. 2 is a diagram illustrating operations for initializing movement of an endpoint between clusters, according to some embodiments.

FIG. 3 is a diagram illustrating operations for moving an endpoint between clusters using the first approach, according to some embodiments.

FIG. 4 is a diagram illustrating operations for moving an endpoint between clusters using the second approach, according to some embodiments.

FIG. 5 is a flow diagram of a process for moving an endpoint between clusters, according to some embodiments.

FIG. 6 is a flow diagram of another process for moving an endpoint between clusters, according to some embodiments.

FIG. 7A illustrates connectivity between network devices (NDs) within an exemplary network, as well as three exemplary implementations of the NDs, according to some embodiments of the invention.

FIG. 7B illustrates an exemplary way to implement a special-purpose network device according to some embodiments of the invention.

### DETAILED DESCRIPTION

The following description describes methods and apparatus for moving an endpoint between clusters in a federated cloud computing system. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, existing federated container orchestration tools can move workloads between clusters located in different clouds, but this involves terminating the old instance in the old cluster and starting a new instance in the new cluster, which results in service interruptions and any state maintained by the old instance being lost.

In contrast to the “break-before-make” approach used by existing techniques, embodiments use a “make-before-break” approach to service mobility to allow a workload (e.g., a microservice or chain of microservices) to be moved between clusters (possibly located in different clouds) while reducing service interruptions and retaining state maintained by the workload.

A first embodiment is a method by one or more computing devices implementing a master orchestrator in a federated cloud computing system to move an endpoint between clusters. The method includes receiving a request to move a first endpoint implemented in a first cluster in a first cloud to another cluster in another cloud, wherein the first endpoint provides a service and uses a first database implemented in the first cluster to store state associated with the service, responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service, causing synchronization between the first database and the second database to begin, causing the first endpoint to connect to the second database, causing the first database to be in a read-only state, causing the first endpoint to use the second database instead of the first database, and causing the first endpoint to pause execution and store any uncommitted state associated with the service in the second database, and causing one or more clients to use the second endpoint instead of the first endpoint in response to a determination that the first database and the second database are synchronized and the first endpoint has stored any uncommitted state in the second database.

A second embodiment is a method by one or more computing devices implementing a master orchestrator in a federated cloud computing system to move an endpoint between clusters. The method includes receiving a request to move a first endpoint implemented in a first cluster in a first cloud to another cluster in another cloud, wherein the first endpoint provides a service and uses a first database implemented in the first cluster to store state associated with the service, responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service, causing synchronization between the first database and the second database to begin, causing the first endpoint to pause execution and store any uncommitted state associated with the service in the first database, and causing one or more clients to use the second endpoint instead of the first endpoint in response to a determination that the first database and the second database are synchronized.

In general, the first embodiment may have less service interruptions compared to the second embodiment but the second embodiment may be faster to complete.

An advantage of embodiments disclosed herein is that they allow for interrupt-free (or almost interrupt-free) service mobility across cluster/cloud boundaries, which helps with providing network reliability, availability, and resilience. Embodiments use an approach that provides more portability compared to a container migration approach, as they allow workloads to move between clusters in different administrative domains (e.g., which may be equipped with different versions of Kubernetes®). Cloud-native workloads (e.g., microservices) typically maintain their state outside of a process/container. Embodiments allow for the migration of such externally-maintained state. Embodiments may be used in conjunction with a container migration approach if both process-internal and externally maintained state needs to be migrated. Embodiments do not require any changes to the federated container orchestration tool (e.g., Federated Kubernetes). The logic for service mobility may be achieved using cloud orchestrators. Embodiments may be used to achieve many 5^{th} Generation Evolution (5GEVO) and/or 6^{th} Generation (6G) services or service chains in a container orchestration system environment (e.g., a Kubernetes environment) that, for example, move between core network and edge cloud, or follow the terminal across different edge clouds. Embodiments are now described herein in additional detail with reference to the accompanying figures.

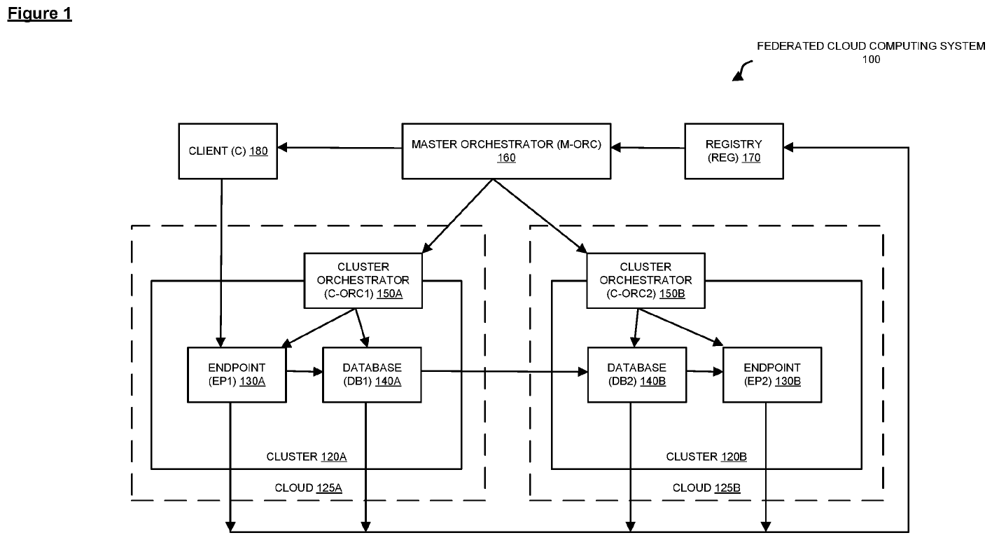

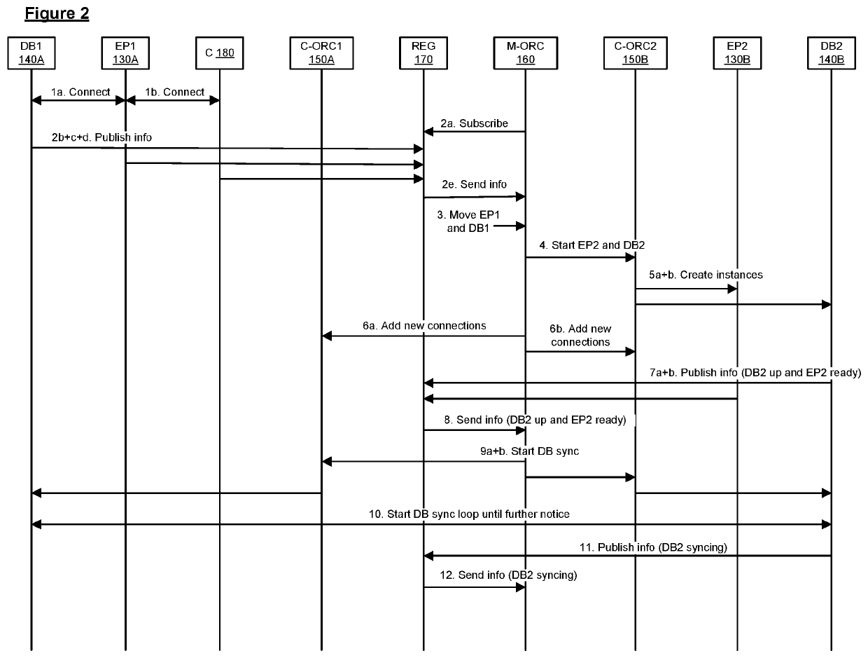

FIG. 1 is a block diagram of a federated cloud computing system in which an endpoint can be moved between clusters, according to some embodiments.

As shown in the diagram, the federated cloud computing system 100 includes a cluster 120A in cloud 125A and a cluster 120B in a cloud 125B. In one embodiment, cloud 125A and cloud 125A belong to different cloud platforms and/or different administrative domains. For example, cloud 125A may be implemented by an Amazon® cloud platform while cloud 125B is implemented by a Microsoft® cloud platform. As another example, cloud 125A may be a private cloud while cloud 125B is a public cloud or vice versa.

Cluster orchestrator 150A may manage cluster 120A while cluster orchestrator 150B manages cluster 120B. Cluster orchestrator 150A may manage cluster 120A by sending instructions to the nodes of cluster 120A and performing other types of cluster management operations. Similarly, cluster orchestrator 150B may manage cluster 120B by sending instructions to the nodes of cluster 120B and performing other types of cluster management operations.

Cluster 120A and cluster 120B may be communicatively coupled to each other over a network. The clusters 120 may establish connectivity with each other using Cilium network plugin for Kubernetes, Submariner.io (an Internet Protocol Security (IPsec) solution), Istio or Linkerd service mesh operating on the application layer, Network Service Mesh (NSM), or similar connectivity solution.

A master orchestrator 160 (designated as “M-ORC)”) may manage cluster 120A via cluster orchestrator 150A (designated as “C-ORC1”) and manage cluster 120B via cluster orchestrator 150B (designated as “C-ORC2”). The master orchestrator 160 may manage the clusters 120A and 120B by sending instructions to the respective cluster orchestrators 150A and 150B. Clusters 120A and 120B may be considered as federated clusters in that they are separate clusters (located in different clouds 125) but managed centrally by the master orchestrator 160. In one embodiment, the master orchestrator 160 directly manages multiple clusters (e.g., cluster 120A and cluster 120B). In such an embodiment, the functionality of the cluster orchestrators 150 may be collapsed/merged into the master orchestrator 160.

The master orchestrator 160 may cause a client 180 (designated as “C”), endpoint 130A (designated as “EP1”), and database 140A (designated as “DB1”) to be deployed in the federated cloud computing system 100 (e.g., as Kubernetes pods). As shown in the diagram, endpoint 130A and database 140A are deployed in cluster 120A. Client 180 is shown in the diagram as being deployed outside of cluster 120A but in other embodiments, client 180 may be deployed in cluster 120A, cluster 120B, or an external cluster.

Endpoint 130A may provide a service that the client 180 can access/consume. For example, endpoint 130A may provide a web back-end service and the client 180 may be a web front-end (e.g., a web browser implemented by a laptop, desktop, table, or mobile phone) that accesses/consumes the web back-end service. As another example, endpoint 130A may provide a service for processing/storing Internet of Things (IoT) sensor data and client 180 may be an IoT sensor that sends sensor data to endpoint 130A for processing/storage. In one embodiment, the client 180 is a reverse Hypertext Transfer Protocol (HTTP) proxy and endpoint 130A is a front-end or web server. In one embodiment, the client 180 is a load balancer or ingress gateway for a container orchestration system such as Kubernetes®. Endpoint 130A may use database 140A to store state associated with the service it provides. The type of state that endpoint 130A stores in database 140A may differ depending on the use case. For example, if endpoint 130A provides a service for processing temperature data captured by IoT sensors, then endpoint 130A may store temperature data received from the client 180 (and possibly one or more other clients) in database 140A. As another example, if endpoint 130A provides a network function/service in a cellular communications network, then endpoint 130A may store instructions on how to forward packets (e.g., a routing table or firewall/network address translation/tunneling rules) in database 140A. Endpoint 130A and/or database 140A may be implemented using one or more containers. In one embodiment, database 140A is embedded into endpoint 130A, for example, as a container located in the same Kubernetes® pod as endpoint 130A. In one embodiment, database 140A is provided as a service by the underlying cloud provider.

As will be described further herein, the master orchestrator 160 may coordinate the “movement” of endpoint 130A (including its state stored in database 140A) from cluster 120A in cloud 125A to cluster 120B in cloud 125B. The master orchestrator 160 may achieve this using cloud-native techniques (e.g., terminating an instance and starting a new instance) instead of using container migration techniques. The master orchestrator 160 may then transfer the state managed by endpoint 130A to the new cluster 120B.

For example, according to some embodiments, the master orchestrator 160 may receive a request to move endpoint 130A to another cluster 120 (e.g., cluster 120B—in some embodiments the request specifies the specific cluster 120B to which endpoint 130A is to be moved, while in other embodiments the request does not specify the specific cluster 120 but the master orchestrator 160 decides which cluster 120 to move endpoint 130A to). Responsive to receiving the request, the master orchestrator 160 may cause (via cluster orchestrator 150B) endpoint 130B and database 140B to be deployed in cluster 120B in cloud 125B, where endpoint 130B is a replica of endpoint 130A and database 140B is a replica of database 140A (but without the state). The master orchestrator 160 may then cause synchronization between database 140A and database 140B to begin. The databases 140 may be synchronized using a direct database synchronization scheme or using a third-party service.

Once database 140A and database 140B are synchronized (or roughly synchronized), the master orchestrator 160 may cause (via cluster orchestrator 150A) endpoint 130A to start using database 140B in cluster 120B instead of using database 140A in cluster 120A. The master orchestrator 160 may then cause the client 180 to use endpoint 130B in cluster 120B instead of using endpoint 130A in cluster 120A. The master orchestrator 160 may then cause (via cluster orchestrator 150A) unused resources in cluster 120A (e.g., endpoint 130A and database 140A) to be terminated. In this manner, endpoint 130A and the state stored in database 140A may be “moved” from cluster 120A (in cloud 125A) to cluster 120B (in cloud 125B).

In one embodiment, as shown in the diagram, the federated cloud computing system 100 includes a registry 170 (designated as “REG”). Entities may subscribe to the registry 170 as a listener to receive information regarding the status of other entities. Entities may publish information regarding their status to the registry 170 to make this status information available to the entities that have subscribed to the registry 170. For example, the master orchestrator 160 may subscribe to the registry 170 as a listener to receive status information published by endpoint 130A, database 140A, endpoint 130B, and database 140B. The registry 170 may be deployed in cluster 120A, cluster 120B, or an external cluster. In one embodiment, the master orchestrator 160 implements the registry 170 (e.g., as an application programming interface (API) in the case of Kubernetes®).

The registry 170 may be implemented in various ways. For example, the registry 170 may be implemented as part of a Kubernetes API/etcd, a service bus, a message queue, a distributed hash table, a Structured Query Language (SQL)/No-SQL database, a document database, or the like. In one embodiment, the registry 170 is implemented as a domain name system (DNS) server that can be updated, for example, using DynDNS messages. As DNS does not typically provide a “subscription” service, the entities using DNS may have to poll for new updates either at regular intervals or upon detecting certain events. While embodiments that use a registry 170 to publish/receive status information are described herein, other embodiments may publish/receive status information using a different mechanism that does not use a registry 170.

For sake of illustration the federated cloud computing system 100 is shown as including two clusters 120 and a single client 180. Most practical implementations will likely include more than two clusters 120 and more than one client 180.

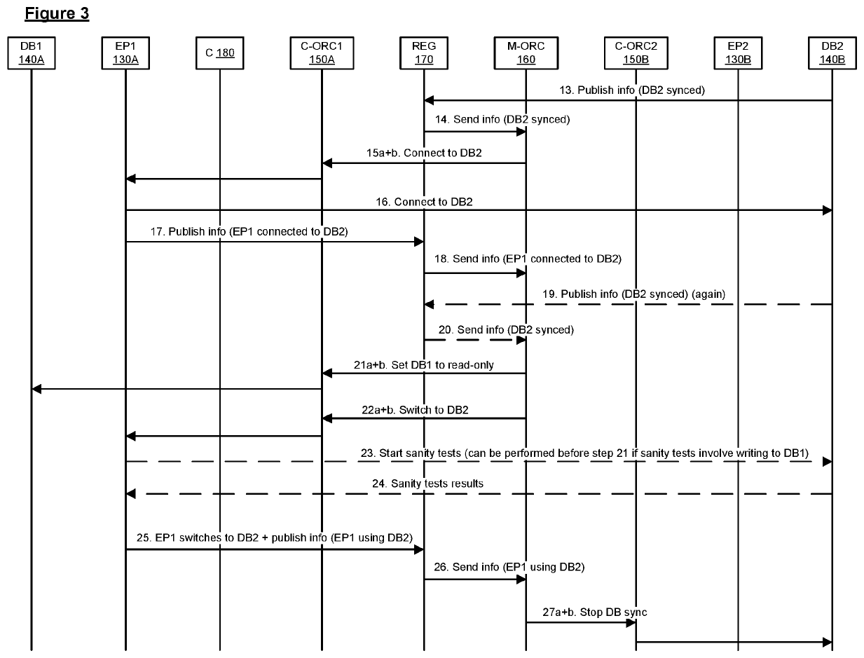

FIG. 2 is a diagram illustrating operations for initializing movement of an endpoint between clusters, according to some embodiments.

At operation 1, M-ORC 160 causes C 180, EP1 130A, and DB1 140A to be deployed, and causes connectivity to be established between EP1 130A and DB1 140A (operation 1a) as well as between C 180 and EP1 130A (operation 1b) (e.g., according to the application manifest). It should be noted that while EP1 130A and DB1 140A are deployed in the same cluster 120A, C 180 may be deployed in the same cluster 120A or elsewhere. Also, C 180, EP1 130A, and DB1 140A have connectivity to REG 170. Establishing connectivity between entities may involve setting up state, creating tunnels, setting up network address translation (NAT) traversal procedures, and/or opening ports in intermediate middleboxes such as firewalls, (virtual) switches, routers and NATs.

At operation 2, M-ORC 160 subscribes to REG 170 as a listener (operation 2a) and DB1 140A (operation 2b), EP1 130A (operation 2c), and C 180 (operation 2d) publish information to REG 170 indicating that they are in an operational state. At operation 2e, M-ORC 160 may receive the information published to REG 170 by DB1 140A, EP1 130A, and C 180.

At operation 3, M-ORC 160 receives a request to move EP1 130A (and DB1 140A) to another cluster. The request may have been manually triggered by a human operator or triggered by an automated process (e.g., via artificial intelligence). For example, an automated process (e.g., implementing intent-based networking (IBN)) may trigger the request based on detecting the movement/mobility of C 180, detecting that the current cluster is experiencing problems, and/or detecting that another cluster has more compute capacity or is otherwise better suited to implement the service provided by EP1 130A.

At operation 4, M-ORC 160 determines that EP1 130A provides a cloud-native service (e.g., this can be determined based on the application manifest or the request itself) and decides to proceed according to a cloud-native methodology. As such, M-ORC 160 sends an instruction to C-ORC2 150B to deploy a replica of EP1 130A (i.e., EP2 130B) and a replica of DB1 140A (i.e., DB2 140B) (without up-to-date state) in cluster 120B (e.g., according to the original application manifest).

At operation 5, C-ORC2 150B receives the instruction from M-ORC 160 and deploys EP2 130B (operation 5a) and DB2 140B (operation 5b) in cluster 120B (e.g., if pre-allocated replicas do not exist in cluster 120B already). C-ORC2 150B may then send an indication to M-ORC 160 (e.g., via REG 170) that the replicas were successfully deployed (not shown).

At operation 6, M-ORC 160 instructs C-ORC1 150A (operation 6a) and C-ORC2 150B (operation 6b) to establish connectivity between EP2 130B and DB2 140B, between C 180 and EP2 130B, between DB1 140A and DB2 140B, and between EP1 130A and DB2 140B. Also, EP2 130B and DB2 140B have connectivity to REG 170.

At operation 7, DB2 140B (operation 7a) and EP2 130B (operation 7b) publish information to REG 170 indicating that they are in an operational state. This is similar to operation 2 except that DB2 140B and EP2 130B may have different instance IDs than DB1 140A and EP1 130A.

At operation 8, M-ORC 160 receives the information published in the previous operation (since M-ORC 160 is subscribed to REG 170 as a listener). The information may be received in one combined message or in multiple separate messages. M-ORC 160 keeps track of the current state of the entities (e.g., using a state machine on the current state of the entities) and updates this information accordingly. M-ORC 160 may use the current state of the entities to determine where it is in the endpoint movement process and the next steps to undertake to complete the endpoint movement process. In Kubernetes, the current state of the entities may be associated to a so called “Kubernetes Operator.”

At operation 9, M-ORC 160 sends instructions to C-ORC1 150A (operation 9a) and C-ORC2 150B (operation 9b), respectively, to cause DB1 140A and DB2 140B to begin synchronizing. The goal is to continuously synchronize the currently empty DB2 140B with DB1 140A so that it will eventually catch up with DB1 140A. The exact details of the synchronization procedure may differ depending on the database implementation (including whether it is a “pull” or “push” type synchronization). The database synchronization may be based on replication or migration (both are possible). Both change-data capture and differential querying are possible. The details of the synchronization procedure may be manually configured in the application manifest or automatically derived from it (or it could have been defined in the request to move EP1 130A at operation 3). It is also possible that M-ORC 160 only contacts one of the databases 140 or cluster orchestrators 150 to trigger the synchronization process to begin.

At operation 10, DB1 140A and DB 140B begin synchronizing with each other. DB1 140A and DB2 140B may continue synchronizing with each other until further notice (e.g., they are in a synchronization loop). At operation 11, DB2 140B publishes information to REG 170 indicating that it has started synchronization procedures with DB1 140A. At operation 12, M-ORC 160 receives this information. In response, M-ORC 160 may update the current state of the entities (e.g., by updating its state machine on the current state of the entities).

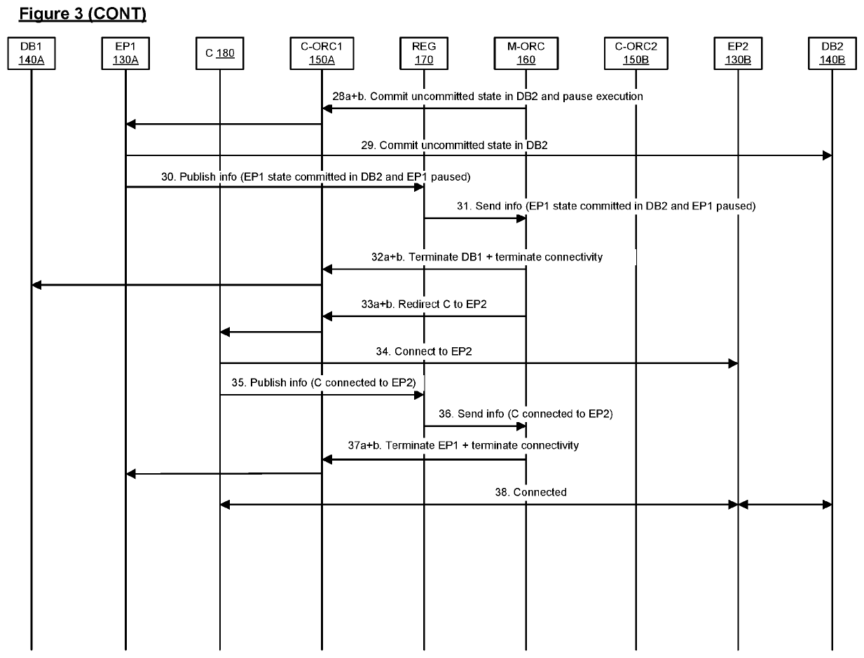

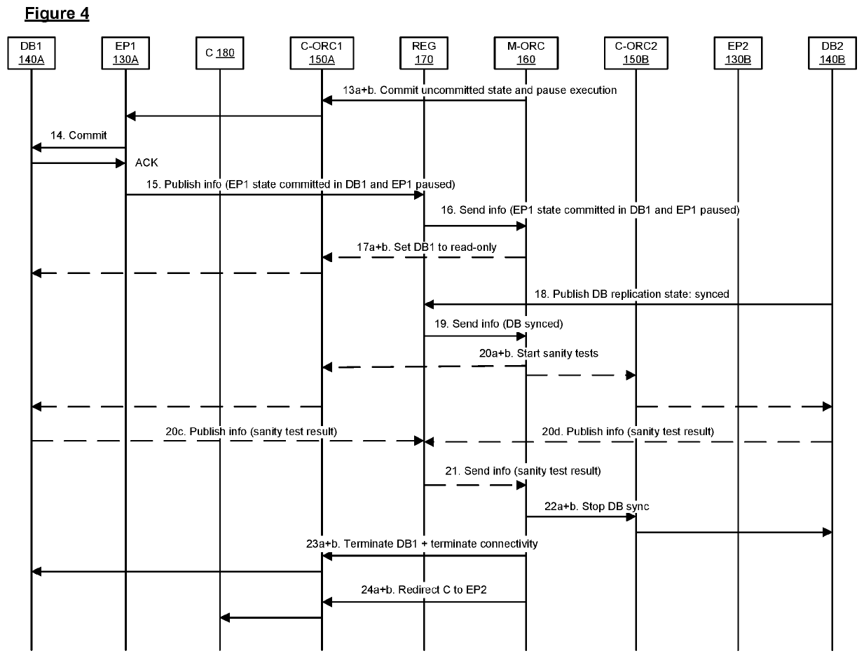

After the above initialization operations have completed (e.g., which M-ORC 160 is able to detect based on the current state of the entities that it maintains (e.g., using its state machine on the current state of the entities)), M-ORC 160 may proceed using one of two different approaches. The first approach reduces service interruptions while the second approach may have more service interruptions but is generally faster to complete. In one embodiment, M-ORC 160 chooses to use one of the approaches based on policy (e.g., whether it is more desirable to have less service interruptions or to have a faster migration). In other embodiments, M-ORC 160 uses just one of the approaches. Example operations of the first approach are shown in FIG. 3 and example operations of the second approach are shown in FIG. 4.

FIG. 3 is a diagram illustrating operations for moving an endpoint between clusters using the first approach, according to some embodiments.

At operation 13, DB2 140B publishes information to REG 170 indicating that it is synchronized with DB1 140A. Depending on the implementation, synchronized here may refer to DB2 140B being fully (one hundred percent) synchronized with DB1 140A, synchronized to a certain degree (e.g., 99 percent synchronized), no new synchronization messages have been received for some time period, or a hard time-out value has passed. The details of what is considered “synchronized” may be pre-configured in the application manifest, specified in the request (e.g., the request received by M-ORC 160 at operation 3), or hard-coded into the application, for instance. At operation 14, M-ORC 160 receives the information published in the previous operation and updates the current state of the entities (e.g., by updating its state machine on the current state of the entities).

At operation 15, M-ORC 160 sends an instruction to C-ORC1 150A for EP1 130A to connect to DB2 140B (operation 15a) and C-ORC1 150A in turn sends an instruction to EP1 130A to connect to DB2 140B (operation 15b). In response, at operation 16, EP1 130A connects to DB2 140B. This new connection is not yet to be utilized by EP1 130A but EP1 130A may keep the connection alive in parallel with its connection to DB1 140A until further notice. Upon connecting to DB2 140B, at operation 17, EP1 130A publishes information to REG 170 indicating that it is connected to DB2 140B. At operation 18, M-ORC 160 receives this information and updates the current state of the entities (e.g., by updating its state machine on the current state of the entities).

In one embodiment, M-ORC 160 waits until it receives information indicating that DB2 140B is synchronized with DB1 140A (again) before proceeding. This may be useful if it is known that EP1 130A makes frequent updates to DB1 140A. Thus, optionally, at operation 19, DB2 140B publishes information to REG 170 indicating that it is synchronized with DB1 140A and at operation 20, M-ORC 160 receives this information and updates the current state of the entities (e.g., by updating its state machine on the current state of the entities).

At operation 21, M-ORC 160 sends an instruction to C-ORC1 150A to set DB1 140A to be in a read-only state (operation 21a) and C-ORC1 150A sets DB1 140A to set itself to be in a read-only state (operation 21b). Setting DB1 140A to a read-only state may allow synchronization to eventually complete (e.g., synchronization may never complete if DB1 140A is not in a read-only state and EP1 130A continues to store new data in DB1 140A).

At operation 22, M-ORC 160 may send an instruction to C-ORC1 150A for EP1 130A to switch to using DB2 140B (instead of using DB1 140A) (operation 22a) and C-ORC1 150A in turn sends an instruction to EP1 130A to switch to using DB2 140B (operation 22b). Some embodiments may skip operation 22, for example, if it is known that DB1 140A is updated very seldomly.

In one embodiment, at operation 23, EP1 130A performs sanity tests on DB2 140B to ensure that DB2 140B is synchronized with DB1 140A. At operation 24, EP1 130A receives the results of the sanity tests from DB2 140B. EP1 130A may verify the results and proceed to the next operation upon successful verification (e.g., if the sanity tests passed). In one embodiment, operations 23 and 24 are repeated until EP1 130A is satisfied with the results of the sanity tests. In one embodiment, the sanity tests are performed before setting DB1 140A to a read-only state if the sanity tests involve writing to DB1 140A. For example, the sanity tests may involve doing a “last insert” to DB1 140A and verifying that it appears in DB2 140B to make sure the draining is complete.

At operation 25, EP1 130A switches to using DB2 140B and publishes information to REG 170 indicating the switch. At operation 26, M-ORC 160 receives this information and updates the current state of the entities (e.g., by updating its state machine on the current state of the entities). The operation of EP1 130A switching to using DB2 140B may be relatively quick since EP1 130A has already established a connection to DB2 140B (e.g., at operation 15).

At operation 27, M-ORC 160 sends an instruction to C-ORC2 150B for DB2 140B to stop synchronizing with DB1 140A (operation 27a) and C-ORC2 150B in turn sends an instruction to DB2 140B to stop synchronization with DB1 140A (operation 27b). In one embodiment, M-ORC 160 sends an instruction to C-ORC1 150A for DB1 140A to stop synchronizing and C-ORC1 150A in turn sends an instruction to DB1 140A to stop synchronizing (in addition to or in lieu of operation 27). The synchronization mechanism could be a push or pull mechanism so the synchronization might have been initiated by either side. Which database to send the stop synchronization instruction to may depend on which synchronization mechanism is being used.

At operation 28, M-ORC 160 sends an instruction to C-ORC1 150A for EP1 130A to store any uncommitted state (e.g., state managed by EP1 130A that has not been stored in a database yet) in DB2 140B and pause execution (operation 28a) and C-ORC1 150A in turn sends an instruction to EP1 130A to store any uncommitted state in DB2 140B and pause execution (operation 28b).

At operation 29, EP1 130A stores any uncommitted state in DB2 140B and pauses execution. EP1 130A may have new state associated with client 180 that has not been stored in a database yet. Operation 29 allows this state to be stored in DB2 140B so that the state is available to EP2 130B when C 180 later switches to using EP2 130B. At operation 30, EP1 130A publishes information to REG 170 indicating that it has stored uncommitted state in DB2 140B and paused execution. At operation 31, M-ORC 160 receives this information and updates the current state of the entities (e.g., by updating its state machine on the current state of the entities).

At operation 32, M-ORC 160 sends an instruction to C-ORC1 150A to terminate DB1 140A and terminate associated connectivity (since DB1 140A is no longer being used) (operation 32a) and C-ORC1 150 in turn terminates DB1 140A and terminates associated connectivity (operation 32b).

At operation 33, M-ORC 160 sends an instruction to C-ORC1 150A for C 180 to use EP2 130B (redirects C 180 to EP2 130B so that C 180 uses EP2 130B instead of EP1 130A) (operation 33a) and C-ORC1 150A in turn sends an instruction to C 180 to use EP2 130B (operation 33b). If there are multiple clients connected to EP1 130A, then C-ORC1 150A may repeat operations 33a (e.g., if there are clients in multiple clusters) and/or 33b (or similar operations) for each of the clients. If a client is located outside any cluster 120, M-ORC 160 may contact that client directly or indirectly (e.g., via REG 170). While an embodiment where M-ORC 160 instructs C 180 to use EP2 130B is shown in the diagram and descried above, in other embodiments, EP1 130A may instruct/inform C 180 to use EP2 130B instead. In one embodiment, if C 180 is subscribed to REG 170 as a listener, then it may switch to using EP2 130B based on information it receives from REG 170.

At operation 34, C 180 connects to EP2 130B and starts using EP2 130B (instead of using EP1 130A). At operation 35, C 180 publishes information to REG 170 indicating that it is using EP2 130B. At operation 36, M-ORC 160 receives this information and updates the current state of the entities (e.g., by updating its state machine on the current state of the entities).

At operation 37, M-ORC 160 sends an instruction to C-ORC1 150A to terminate EP1 130A and terminate associated connectivity (since EP1 130A is no longer being used) (operation 37a) and C-ORC1 150A in turn terminates EP1 130A and terminates associated connectivity (operation 37b).

At operation 38, the result is that EP1 130A and DB1 140A, along with all network connectivity to them are cleared from cluster 120A. C 180 is now using EP2 130B. EP2 130B is deployed in cluster 120B and connected to DB2 140B. State has been migrated from DB1 140A to DB2 140B. As such, EP1 130A (the service it provides, and the state associated with the service) has been effectively “moved” from cluster 120A to cluster 120B.

FIG. 4 is a diagram illustrating operations for moving an endpoint between clusters using the second approach, according to some embodiments.

At operation 13, M-ORC 160 sends an instruction to C-ORC1 150A for EP1 130A to store any uncommitted state (e.g., state managed by EP1 130A that has not been stored in a database yet) in DB1 140A and pause execution (operation 13a) and C-ORC1 150A in turn sends an instruction to EP1 130A to store any uncommitted state in DB 140A and pause execution (operation 13b). At operation 14, EP1 130A stores any uncommitted state in DB1 140A and DB1 140A sends an acknowledgement (ACK) message to EP1 130A if the operation is successful. EP1 130A may then pause execution. At operation 15, EP1 130A publishes information to REG 170 indicating that its state is stored in DB1 140A and that it has paused execution. At operation 16, M-ORC 160 receives this information and updates the current state of the entities (e.g., by M-ORC 160 updating its state machine on the current state of the entities).

In one embodiment, at operation 17, M-ORC 160 sends an instruction to C-ORC1 150A to set DB1 140A to a read-only state (operation 17a) and C-ORC1 150A in turn sets DB1 140A to a read-only state (operation 17b). This operation is optional because DB1 140A is (at least theoretically) not being used for storing new information, as EP1 130A has paused execution (this operation provides an additional safeguard).

At operation 18, DB2 140B publishes information to REG 170 indicating that it is synchronized with DB1 140A. At operation 19, M-ORC 160 receives this information and updates the current state of the entities (e.g., by updating its state machine on the current state of the entities).

In one embodiment, at operation 20, M-ORC 160 sends instructions to C-ORC1 150A (operation 20a) and C-ORC2 150B (operation 20B), respectively, to cause DB1 140A and DB2 140B to perform sanity tests to ensure that they are synchronized with each other. DB1 140A and DB2 140B may perform the sanity tests and publish information to REG 170 indicating the result of the sanity tests (operations 20c and 20d). At operation 21, M-ORC 160 receives this information (via REG 180). M-ORC 160 may verify the result and proceed to the next operation upon successful verification.

At operation 22, M-ORC 160 sends an instruction to C-ORC2 150B for DB2 140B to stop synchronizing with DB1 140A (operation 22a) and C-ORC2 150B in turn sends an instruction to DB2 140B to stop synchronization with DB1 140A (operation 22b).

At operation 23, M-ORC 160 sends an instruction to C-ORC1 150A to terminate DB1 140A and terminate associated connectivity (operation 23a) and C-ORC1 150A in turn terminates DB1 140A and terminates associated connectivity (operation 23b).

At operation 24, M-ORC 160 sends an instruction to C-ORC1 150 for C 180 to use EP2 130B (redirects C 180 to EP2 130B so that C 180 uses EP2 130B instead of EP1 130A) (operation 24a) and C-ORC1 150 in turn sends an instruction to C 180 to use EP2 130B (operation 24b). If there are multiple clients connected to EP1 130A, then C-ORC1 150A may repeat operations 24a and/or 24b (or similar operations) for each of the clients. While an embodiment where M-ORC 160 instructs C 180 (via C-ORC1 150A) to use EP2 130B is shown in the diagram and descried above, in other embodiments, C 180 may determine that it is to switch to using EP2 130B using other means (e.g., EP1 130A may instruct/inform C 180 to use EP2 130B or C 180 may determine that it should switch to using EP2 130B on its own based on information it receives from REG 170).

At operation 25, C 180 connects to EP2 130B and starts using EP2 130B (instead of using EP1 130A). At operation 26, C 180 publishes information to REG 170 indicating that it is using EP2 130B. At operation 27, M-ORC 160 receives this information and updates the current state of the entities (e.g., by updating its state machine on the current state of the entities).

At operation 28, M-ORC 160 sends an instruction to C-ORC1 150A to terminate EP1 130A and terminate associated connectivity (since EP1 130A is no longer being used) (operation 28a) and C-ORC1 150A in turn terminates EP1 130A and terminates associated connectivity (operation 28b).

At operation 29, the result is that EP1 130A and DB1 140A, along with all network connectivity to them are cleared from cluster 120A. C 180 is now using EP2 130B. EP2 130B is deployed in cluster 120B and connected to DB2 140B. State has been migrated from DB1 140A to DB2 140B. As such, EP1 130A (the service it provides, and the state associated with the service) has been effectively “moved” from cluster 120A to cluster 120B.

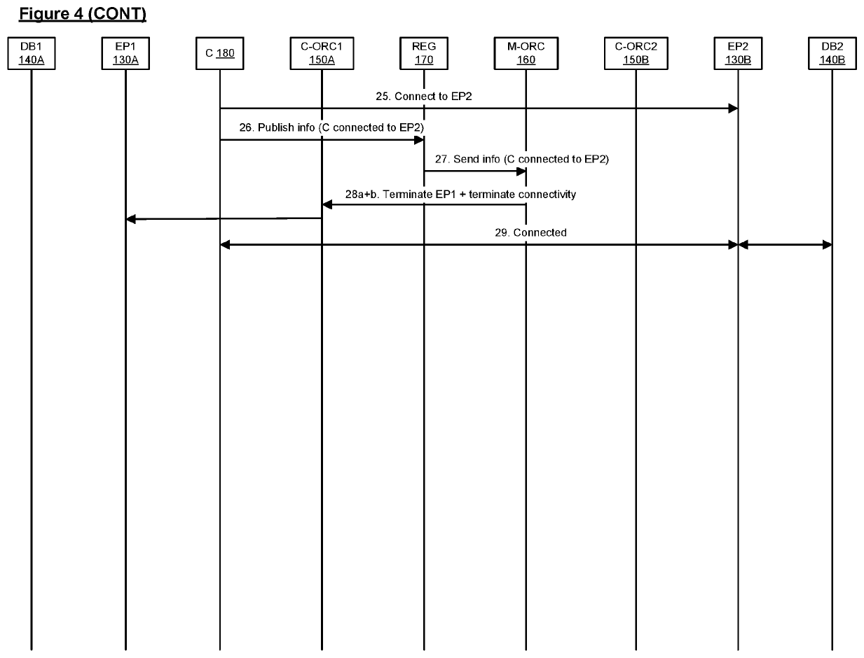

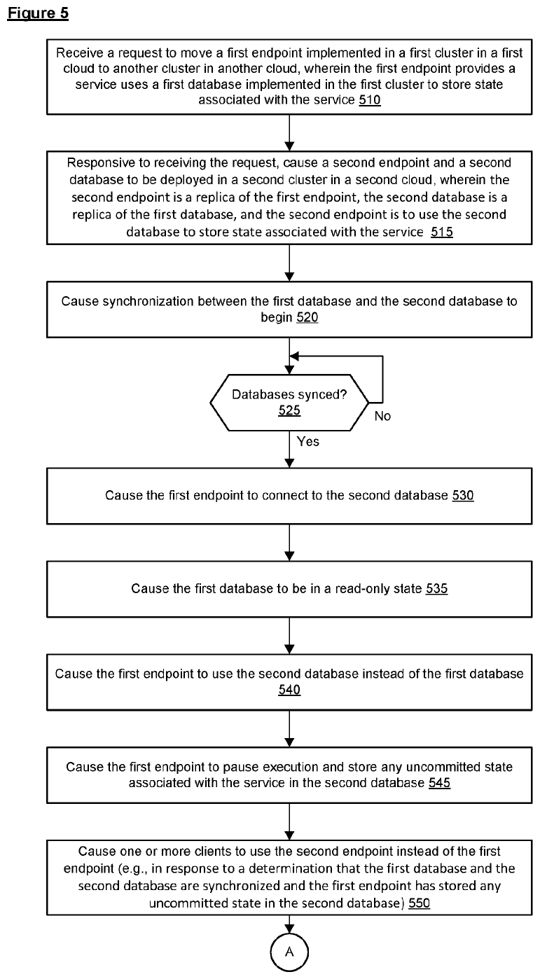

FIG. 5 is a flow diagram of a process for moving an endpoint between clusters, according to some embodiments. The process uses the first approach mentioned above (the approach that has less service interruptions). In one embodiment, the process is implemented by one or more computing devices implementing a master orchestrator in a federated cloud computing system. The process may be implemented using hardware, software, and/or firmware.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

At block 510, the master orchestrator receives a request to move a first endpoint implemented in a first cluster in a first cloud to another cluster in another cloud, wherein the first endpoint provides a service uses a first database implemented in the first cluster to store state associated with the service. In one embodiment, he first endpoint provides a service that is consumed by one or more clients. In one embodiment, the one or more clients include a load balancer or ingress gateway for a container orchestration system. In one embodiment, the one or more clients include a reverse HTTP proxy.

Responsive to receiving the request, at block 515, the master orchestrator causes a second endpoint and a second database to be deployed in a second cluster in a second cloud, wherein the second endpoint is a replica of the first endpoint, the second database is a replica of the first database, and the second endpoint is to use the second database to store state associated with the service. In one embodiment, the master orchestrator is communicatively coupled to a first cluster orchestrator that manages the first cluster and a second cluster orchestrator that manages the second cluster, wherein the master orchestrator manages the first cluster based on sending instructions to the first cluster orchestrator and manages the second cluster based on sending instructions to the second cluster.

At block 520, the master orchestrator causes synchronization between the first database and the second database to begin.

At decision block 525, the master orchestrator determines whether the first database and the second database are synced. If not, the master orchestrator waits until the databases are synced.

If the databases are synced, at block 530, the master orchestrator causes the first endpoint to connect to the second database. In one embodiment, the first endpoint maintains a connection to the second database in parallel with a connection to the first database at least until the first endpoint starts using the second database.

At block 535, the master orchestrator causes the first database to be in a read-only state.

At block 540, the master orchestrator causes the first endpoint to use the second database instead of the first database (to store state associated with the service). In one embodiment, the master orchestrator causes the first endpoint to determine whether the second database is synchronized with the first database, wherein the first endpoint starts using the second database instead of the first database in response to a determination that the second database is synchronized with the first database.

At block 545, the master orchestrator causes the first endpoint to pause execution and store any uncommitted state associated with the service in the second database.

At block 550, the master orchestrator causes one or more clients to use the second endpoint instead of the first endpoint (e.g., in response to a determination that the first database and the second database are synchronized and the first endpoint has stored any uncommitted state in the second database).

At block 555, the master orchestrator causes the first database to be terminated (e.g., in response to a determination that the first endpoint has started using the second database instead of the first database).

At block 560, the master orchestrator causes the first endpoint to be terminated (e.g., in response to a determination that the one or more clients are using the second endpoint).

In one embodiment, the master orchestrator subscribes to a registry to receive status information published by the first endpoint, the first database, the second endpoint, the second database, and the one or more clients.

In one embodiment, the master orchestrator causes connectivity to be established between various entities in the federated cloud computing system. For example, the master orchestrator may cause connectivity to be established between the second endpoint and the second database, between the one or more clients and the second endpoint, between the first database and the second database, and/or between the first endpoint and the second database.

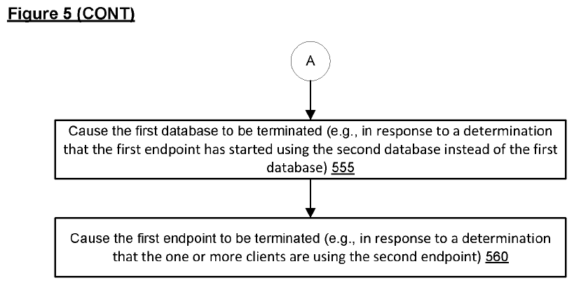

FIG. 6 is a flow diagram of another process for moving an endpoint between clusters, according to some embodiments. The process uses the second approach mentioned above (the approach that may have more service interruptions but is generally faster to complete). In one embodiment, the process is implemented by one or more computing devices implementing a master orchestrator in a federated cloud computing system. The process may be implemented using hardware, software, and/or firmware.

At block 610, the master orchestrator receives a request to move a first endpoint implemented in a first cluster in a first cloud to another cluster in another cloud, wherein the first endpoint provides a service uses a first database implemented in the first cluster to store state associated with the service. In one embodiment, the first endpoint provides a service that is consumed by one or more clients. In one embodiment, the one or more clients include a load balancer or ingress gateway for a container orchestration system.

Responsive to receiving the request, at block 620, the master orchestrator causes a second endpoint and a second database to be deployed in a second cluster in a second cloud, wherein the second endpoint is a replica of the first endpoint, the second database is a replica of the first database, and the second endpoint is to use the second database to store state associated with the service. In one embodiment, the master orchestrator is communicatively coupled to a first cluster orchestrator that manages the first cluster and a second cluster orchestrator that manages the second cluster, wherein the master orchestrator manages the first cluster based on sending instructions to the first cluster orchestrator and manages the second cluster based on sending instructions to the second cluster.

At block 630, the master orchestrator causes synchronization between the first database and the second database to begin.

At block 640, the master orchestrator causes the first endpoint to pause execution and store any uncommitted state associated with the service in the first database.

In one embodiment, at block 650, the master orchestrator causes the first database to be in a read-only state.

At decision block 660, the master orchestrator determines whether the first database and the second database are synced. If not, the master orchestrator waits until the databases are synced.

If the databases are synced, at block 670, the master orchestrator causes one or more clients to use the second endpoint instead of the first endpoint.

At block 680, the master orchestrator causes the first database to be terminated (after the first database and the second database are synchronized).

At block 690, the master orchestrator causes the first endpoint to be terminated (e.g., in response to a determination that the one or more clients are using the second endpoint).

Embodiments may be extended to handle the movement of entire service chains. For example, endpoint 130A may be a client with respect to another endpoint, which could also be a client with respect to yet another endpoint, which results in a service chain. This service chain can be moved by using the techniques described herein to moving the endpoints recursively in reverse order (e.g., moving the end of the service chain first, then moving the middle of the service chain, and then moving the beginning of the service chain).

While embodiments have been described in the context of container-based environments, the techniques disclosed herein are also applicable to environments that use virtual machines and/or other types of virtual appliances.

If containers are being used, it is possible that some of the logic from the client 180 or endpoint 130 is externalized into what is sometimes called a “sidecar” container that handles some of the logic on behalf of the client 180 or endpoint 130 container. In the case of Kubernetes, the sidecar container may be located in the same pod as the client 180 or endpoint 130 container.

Embodiments disclosed herein support active-passive migration which is simpler to achieve than active-active migration. With active-passive migration, it is easier to guarantee migration consistency (e.g., complete, duplicate free, and ordered).

Embodiments disclosed herein may be implemented using homogeneous migration instead heterogenous migration (e.g., the latter may require a complex third-party migration service). Embodiments may make 1:1 database migration cardinality possible, which can simplify implementation.

The second approach described above (the “faster” approach) may be realized with even simpler database synchronization mechanisms such as export/import or backup/restore mechanisms because it assumes more downtime is acceptable.

As an optimization, if the client is a load balancer or ingress gateway (or the client is behind such an entity), the orchestrator can stop load balancing new data flows to the moved service.

While embodiments have been described where the database(s) (e.g., DB1 140A and/or DB2 140B) report the state migration, it is possible in some embodiments that the endpoints (e.g., EP1 130A and/or EP2) are responsible for initiating and reporting the state migration.

In one embodiment, database 140A is shared by multiple endpoints 130. For example, data can be partitioned into separate tables within database 140A for each endpoint 130. In this case, it may not always be completely terminated if there are active users using database 140A. In one embodiment, the user count can be reduced whenever an endpoint stops using database 140A and database 140A is terminated when the user count reaches zero. In one embodiment, database 140A may not be terminated if it is provided as a service by the underlying cloud provider.

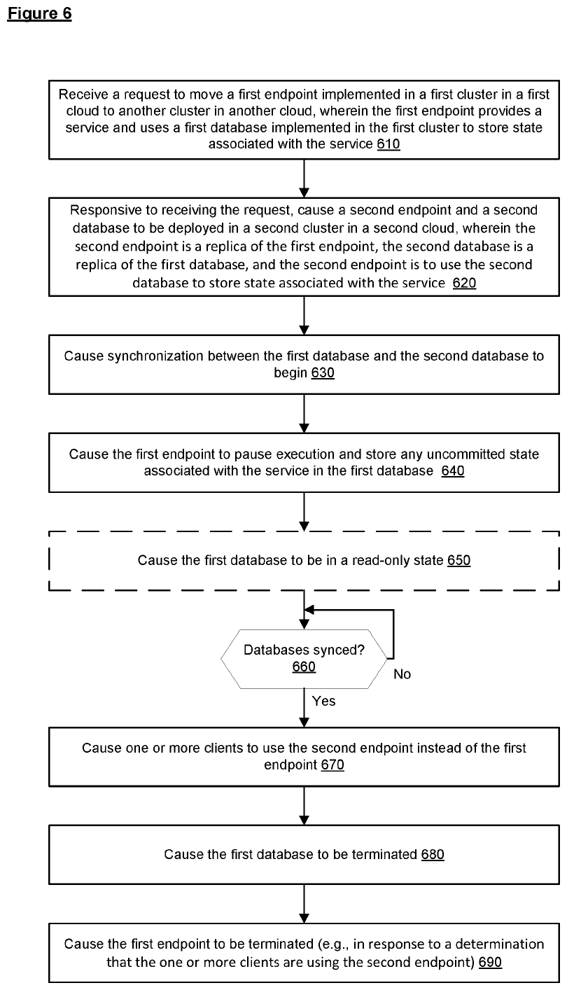

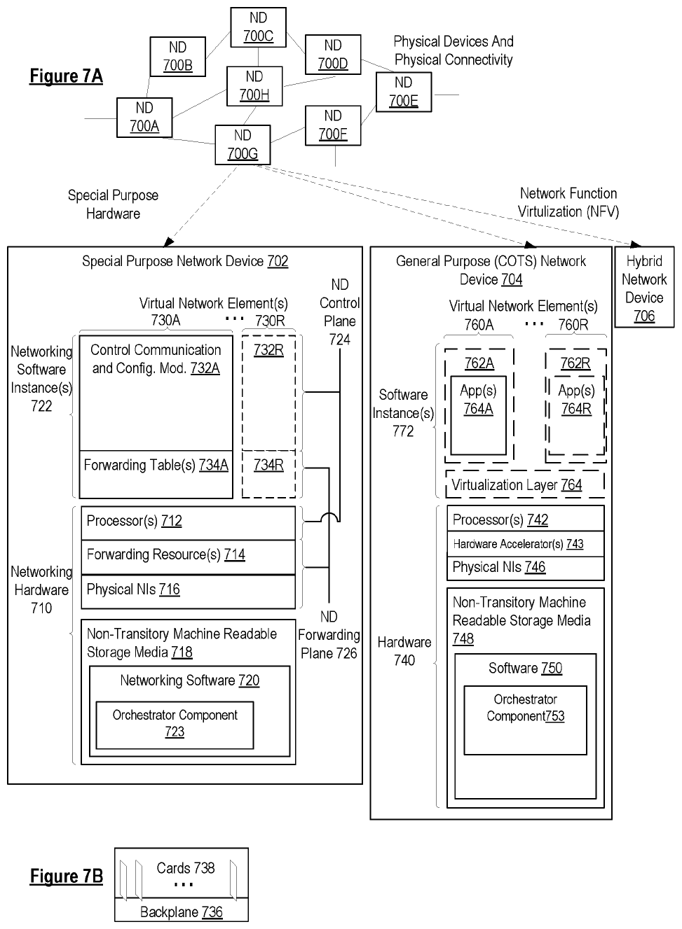

FIG. 7A illustrates connectivity between network devices (NDs) within an exemplary network, as well as three exemplary implementations of the NDs, according to some embodiments of the invention. FIG. 7A shows NDs 700A-H, and their connectivity by way of lines between 700A-700B, 700B-700C, 700C-700D, 700D-700E, 700E-700F, 700F-700G, and 700A-700G, as well as between 700H and each of 700A, 700C, 700D, and 700G. These NDs are physical devices, and the connectivity between these NDs can be wireless or wired (often referred to as a link). An additional line extending from NDs 700A, 700E, and 700F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated-circuits (ASICs) and a special-purpose operating system (OS); and 2) a general purpose network device 704 that uses common off-the-shelf (COTS) processors and a standard OS.

The special-purpose network device 702 includes networking hardware 710 comprising a set of one or more processor(s) 712, forwarding resource(s) 714 (which typically include one or more ASICs and/or network processors), and physical network interfaces (NIs) 716 (through which network connections are made, such as those shown by the connectivity between NDs 700A-H), as well as non-transitory machine readable storage media 718 having stored therein networking software 720. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A).

In one embodiment software 720 includes code such as orchestrator component 723, which when executed by networking hardware 710, causes the special-purpose network device 702 to perform operations of one or more embodiments of the present invention as part of networking software instances 722 (e.g., to move an endpoint between clusters that are potentially located in different clouds).

The special-purpose network device 702 is often physically and/or logically considered to include: 1) a ND control plane 724 (sometimes referred to as a control plane) comprising the processor(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the processor(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments of the invention. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general purpose network device 704 includes hardware 740 comprising a set of one or more processor(s) 742 (which are often COTS processors) and physical NIs 746, as well as non-transitory machine readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 754 represents a hypervisor (sometimes referred to as a virtual machine monitor (VMM)) or a hypervisor executing on top of a host operating system, and each of the sets of applications 764A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers).

The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual network element(s) 760A-R.

The virtual network element(s) 760A-R perform similar functionality to the virtual network element(s) 730A-R—e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 762A-R to VNEs also apply to embodiments where such a finer level of granularity and/or unikernels are used.

In certain embodiments, the virtualization layer 754 includes a virtual switch that provides similar forwarding services as a physical Ethernet switch. Specifically, this virtual switch forwards traffic between instances 762A-R and the physical NI(s) 746, as well as optionally between the instances 762A-R; in addition, this virtual switch may enforce network isolation between the VNEs 760A-R that by policy are not permitted to communicate with each other (e.g., by honoring virtual local area networks (VLANs)).

In one embodiment, software 750 includes code such as orchestration component 753, which when executed by processor(s) 742, causes the general purpose network device 704 to perform operations of one or more embodiments of the present invention as part of software instances 762A-R (e.g., to move an endpoint between clusters that are potentially located in different clouds).

The third exemplary ND implementation in FIG. 7A is a hybrid network device 706, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method by one or more computing devices implementing a master orchestrator in a federated cloud computing system to move an endpoint between clusters, the method comprising:
receiving a request to move a first endpoint implemented in a first cluster in a first cloud to another cluster in another cloud, wherein the first endpoint provides a service and uses a first database implemented in the first cluster to store state associated with the service;
responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service;
causing synchronization between the first database and the second database to begin;
causing the first endpoint to connect to the second database;
causing the first database to be in a read-only state;
causing the first endpoint to use the second database instead of the first database;
causing the first endpoint to pause execution and store any uncommitted state associated with the service in the second database; and
causing one or more clients to use the second endpoint instead of the first endpoint in response to a determination that the first database and the second database are synchronized, and the first endpoint has stored any uncommitted state in the second database.

2. The method of claim 1, further comprising:
subscribing to a registry to receive status information published by the first endpoint, the first database, the second endpoint, the second database, and the one or more clients.

3. The method of claim 1, wherein the first endpoint maintains a connection to the second database in parallel with a connection to the first database at least until the first endpoint starts using the second database.

4. The method of claim 1, further comprising:
causing the first endpoint to determine whether the second database is synchronized with the first database, wherein the first endpoint starts using the second database instead of the first database in response to a determination that the second database is synchronized with the first database.

5. The method of claim 1, further comprising:
causing connectivity to be established between the second endpoint and the second database;
causing connectivity to be established between the one or more clients and the second endpoint;
causing connectivity to be established between the first database and the second database; and
causing connectivity to be established between the first endpoint and the second database.

6. The method of claim 1, further comprising:
causing the first database to be terminated in response to a determination that the first endpoint has started using the second database instead of the first database.

7. The method of claim 1, further comprising:
causing the first endpoint to be terminated in response to a determination that the one or more clients are using the second endpoint.

8. The method of claim 1, wherein the first endpoint provides a service that is consumed by the one or more clients.

9. The method of claim 1, wherein the master orchestrator is communicatively coupled to a first cluster orchestrator that manages the first cluster and a second cluster orchestrator that manages the second cluster, wherein the master orchestrator manages the first cluster based on sending instructions to the first cluster orchestrator and manages the second cluster based on sending instructions to the second cluster.

10. The method of claim 1, wherein the one or more clients include a load balancer or ingress gateway for a container orchestration system.

11. A method by one or more computing devices implementing a master orchestrator in a federated cloud computing system to move an endpoint between clusters, the method comprising:
receiving a request to move a first endpoint implemented in a first cluster in a first cloud to another cluster in another cloud, wherein the first endpoint provides a service and uses a first database implemented in the first cluster to store state associated with the service;
responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service;
causing synchronization between the first database and the second database to begin;
causing the first endpoint to pause execution and store any uncommitted state associated with the service in the first database; and
causing one or more clients to use the second endpoint instead of the first endpoint in response to a determination that the first database and the second database are synchronized.

12. The method of claim 11, further comprising:
causing the first database to be terminated after the first database and the second database are synchronized.

13. The method of claim 11, further comprising:
causing the first endpoint to be terminated in response to a determination that the one or more clients are using the second endpoint.

14. The method of claim 11, wherein the first endpoint provides a service that is consumed by the one or more clients.

15. The method of claim 11, wherein the master orchestrator is communicatively coupled to a first cluster orchestrator that manages the first cluster and a second cluster orchestrator that manages the second cluster, wherein the master orchestrator manages the first cluster based on sending instructions to the first cluster orchestrator and manages the second cluster based on sending instructions to the second cluster.

16. The method of claim 11, wherein the one or more clients include a load balancer or ingress gateway for a container orchestration system.

17. A set of non-transitory machine-readable media having computer code stored therein, which when executed by a set of one or more processors of one or more computing device implementing a master orchestrator in a federated cloud computing system, causes the master orchestrator to perform operations for moving an endpoint between clusters, the operations comprising:
receiving a request to move a first endpoint implemented in a first cluster in a first cloud to another cluster in another cloud, wherein the first endpoint provides a service and uses a first database implemented in the first cluster to store state associated with the service;
responsive to receiving the request, causing a second endpoint and a second database to be deployed in a second cluster in a second cloud, wherein the second endpoint is a replica of the first endpoint, the second database is a replica of the first database, and the second endpoint is to use the second database to store state associated with the service;
causing synchronization between the first database and the second database to begin;
causing the first endpoint to connect to the second database;
causing the first database to be in a read-only state;
causing the first endpoint to use the second database instead of the first database;
causing the first endpoint to pause execution and store any uncommitted state associated with the service in the second database; and
causing one or more clients to use the second endpoint instead of the first endpoint in response to a determination that the first database and the second database are synchronized, and the first endpoint has stored any uncommitted state in the second database.

18. The set of non-transitory machine-readable media of claim 17, wherein the master orchestrator is communicatively coupled to a first cluster orchestrator that manages the first cluster and a second cluster orchestrator that manages the second cluster, wherein the master orchestrator manages the first cluster based on sending instructions to the first cluster orchestrator and manages the second cluster based on sending instructions to the second cluster.

19. A computing device to implement a master orchestrator in a federated cloud computing system to move an endpoint between clusters, the computing device comprising:
one or more processors; and
a non-transitory machine-readable medium having computer code stored therein, which when executed by the one or more processors, causes the master orchestrator to:
receive a request to move a first endpoint implemented in a first cluster in a first cloud to another cluster in another cloud, wherein the first endpoint provides a service and uses a first database implemented in the first cluster to store state associated with the service;
responsive to receiving the request, cause a second endpoint and a second database to be deployed in a second cluster in a second cloud, wherein the second endpoint is a replica of the first endpoint, the second database is a replica of the first database, and the second endpoint is to use the second database to store state associated with the service;
cause synchronization between the first database and the second database to begin;
cause the first endpoint to connect to the second database;
cause the first database to be in a read-only state;
cause the first endpoint to use the second database instead of the first database;
cause the first endpoint to pause execution and store any uncommitted state associated with the service in the second database; and
cause one or more clients to use the second endpoint instead of the first endpoint in response to a determination that the first database and the second database are synchronized, and the first endpoint has stored any uncommitted state in the second database.

20. The computing device of claim 19, wherein the master orchestrator is communicatively coupled to a first cluster orchestrator that manages the first cluster and a second cluster orchestrator that manages the second cluster, wherein the master orchestrator manages the first cluster based on sending instructions to the first cluster orchestrator and manages the second cluster based on sending instructions to the second cluster.
